(19) United States
(12) Patent Application Publication
(10) Pub. No.: US 2024/0038416 A1
(43) Pub. Date: Feb. 1, 2024

(54) OPTIMIZED WIRE SEPARATOR FOR TWISTED WIRE-PAIR APPLICATIONS

(71) Applicant: Panduit Corp., Tinley Park, IL (US)

(72) Inventors: Paul W. Wachtel, Arlington Heights, IL (US); Ronald A. Nordin, Naperville, IL (US); Royal O. Jenner, Frankfort, IL (US)

(73) Assignee: Panduit Corp., Tinley Park, IL (US)

(21) Appl. No.: 18/378,175

(22) Filed: Oct. 10, 2023

Related U.S. Application Data
(63) Continuation-in-part of application No. 17/411,749, filed on Aug. 25, 2021.

(51) Int. Cl. H01B 11/02

(52) U.S. Cl. CPC H01B 11/02

(57) ABSTRACT

A communications cable has coated conductor wires separated by a wire separator with at least one hole in the cross section to form a twisted pair configured to maintain a distance of approximately 0.375 mm between the conductors and a characteristic impedance of approximately 100 ohms. The coating on the conductors may be an enamel or other appropriately thin insulating material.

### CROSS REFERENCE TO RELATED APPLICATION(S)

This application is a continuation-in-part of U.S. patent application Ser. No. 17/411,749, filed Aug. 25, 2021, the entirety of which is hereby incorporated by reference herein.

### FIELD OF INVENTION

The present invention relates generally to communication cables and more specifically, to communication cables utilizing a separator between wires forming a twisted pair that maintains a specific distance between wires.

### BACKGROUND

Traditional category cabling such as Cat 6a is manufactured using common processes of insulating individual conductors, twinning (twisting) two insulated conductors together to form a twisted pair, and stranding four twisted pairs together to form a cable. The four pairs may be stranded together with a dividing member, or cross web, to create distance between the pairs. In addition, the four pairs may be enclosed circumferentially by barrier layers such as Matrix Tape to achieve a desired electrical characteristic. Ultimately, the entire cable is enclosed inside an outer jacket. An example of a modern Cat 6a cable such as the cable is shown in FIG. 1.

There is a constant desire to reduce the cost and size of category cabling to gain market share and competitive advantages over the competition. Recent advancements in the twinning process have allowed the removal of the dividing member resulting in an optimized cable shown in FIG. 2. This cable design is approaching the limits of size and cost reduction for a cable manufactured by the traditional processes and materials.

SUMMARY

A communications cable has coated conductor wires separated by a wire separator having at least one hole in the cross section to form a twisted pair configured to maintain a distance of approximately 0.375 mm between the conductors and a characteristic impedance of approximately 100 ohms. The coating on the conductors may be an enamel or other appropriately thin insulating material.

### BRIEF DESCRIPTION OF THE DRAWINGS

Fig shows a cross-sectional view of a prior art cable.

FIG. 2 shows another cross-sectional view of a prior art cable that is similar to FIG. 1 but with the dividing member removed.

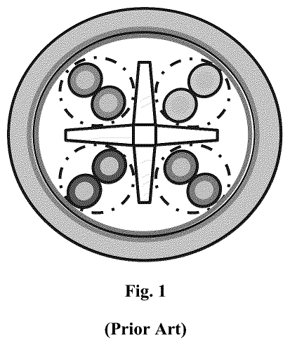

FIG. 3 is a cross-sectional view of a prior art pair of insulated conductors.

FIG. 4 is a cross-sectional view of a pair of conductors separated by a wire separator.

FIG. 5 is a cross-sectional view of a communications cable utilizing the wire separator of FIG. 4.

FIG. 6 shows a cross-sectional view of an alternative embodiment a wire separator with a hole located in the center of thy: cross-section.

FIG. 7 shows a cross-sectional view of a second alternative er embodiment of a wire separator with multiple holes located in the cross-section.

### DESCRIPTION OF INVENTION

Traditional twisted pairs found in Cat 6a cabling are made from two individually insulated conductors. The insulation around the conductor serves two primary electrical purposes. Electrically, it prevents the conductor from shorting to nearby conductors and ensures the cables ability to withstand high DC voltages. The thickness of the insulation also serves the purpose of providing a specific amount of separation between two twisted conductors. This separation is critical to achieve a specific characteristic impedance of the twisted pair when used as a differential transmission line. Typically, this characteristic impedance is targeted to be 100 ohms +/- 10 ohms.

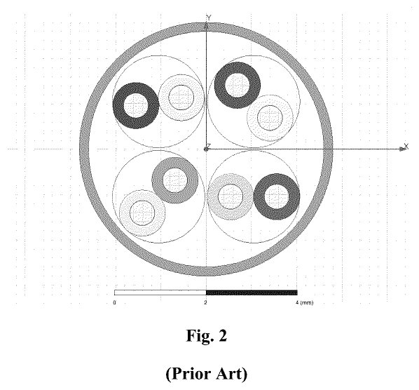

Because the insulation is extruded around the entire circumference of the conductors, the total diameter of the twisted pair orbit (2.1 mm) is determined by the diameter of the insulation surrounding each conductor as shown in FIG. 3.

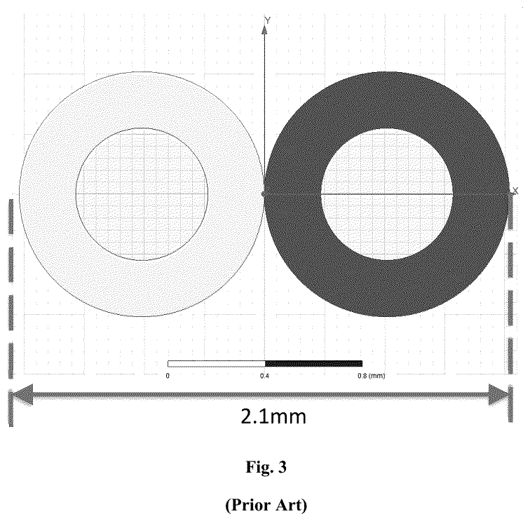

FIG. 4 shows a novel construction of a twisted pair with two enamel coated conductors with a wire separator positioned between the conductors. The wire separator can be fabricated in a separate manufacturing process such as extrusion and made from an appropriate dielectric material such as FEP, HDPE, or others. These same materials are also used in traditional wire insulation processes, and therefore suitable for Cat 6a cable applications. Based on the known material properties, the critical dimension of the pair separator, which defines the spacing between the conductors, was calculated to be 0.45 mm for a HDPE dielectric. A wire separator fabricated from other materials may result in critical dimensions different than 0.45 mm.

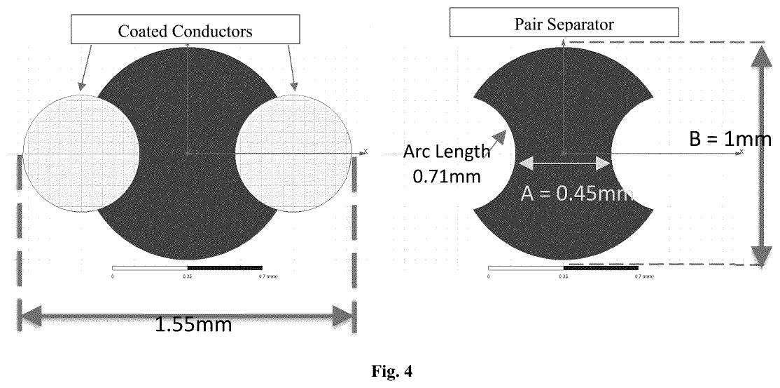

The novel twisted pair orbit diameter (1.55 mm) is now determined by the diameter of the coated conductors and the critical dimension of the wire separator shown in FIG. 4. Compared to a traditional twisted pair construction, the orbit diameter is substantially smaller. Translating these dimensions into a four pair cable design shows a significant potential for size reduction as shown in FIG. 5.

In addition to the reduction in size, the amount of dielectric insulating material is substantially reduced by implementing the novel twisted pair construction. The profile of the pair separator shown in FIG. 4 has a surface area of 893 mils³ per pair; therefore, the total volume of insulating material within a 100 meter four pair cable is approximately 719 cubic centimeters. The profile of traditional insulated conductors as shown in FIG. 3 has an insulation surface area of 1708 mils² per pair; therefore, the total volume of insulating material within a 100 meter four pair cable is approximately 1375 cubic centimeters. A reduction of 48% in insulation material is achieved by implementing a cable with novel twisted pairs. This reduction in insulation material volume is very significant to the overall cost, especially for plenum rated cables where the wire insulation is typically the most expensive raw material in the cable.

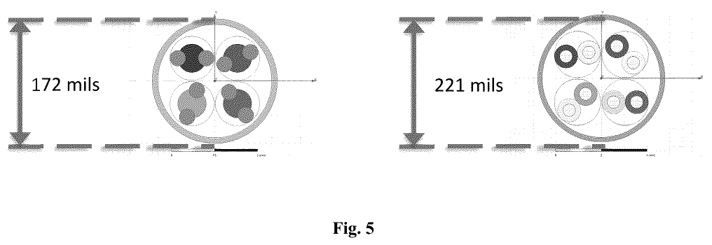

FIG. 6 shows the pair separator now with a hole located in the center. This hole can easily be introduced during the extrusion process as it is commonly done in the manufacturing of small tubing. The introduction of this hole lowers the effective dielectric constant of the pair separator which leads to several improvements:
1. Enabling the target characteristic impedance (100-ohms) to be achieved with a smaller pair separator.
2. Further decreasing the volume of dielectric material used in a cable; hence, providing more cost savings.
3. Increasing the propagation velocity of the differential mode signal which improves signal delay and can improve delay skew. This impact can be leveraged in the cable design to consider tighter and longer pair lays that would otherwise violate delay and skew requirements.

The dielectric constant (Dk) of the material between the two conductors of a pair will largely dictate the capacitance between the conductors. This capacitance in turn directly relates to the differential characteristic impedance of the pair which is designed to nominally be maintained at 100 ohms. During differential mode transmission over a twisted pair, an electric field is present between the two conductors. The vast majority of this field exists within the volume of the dielectric pair separator which is why its Dk along with its size, largely defines the capacitance and the characteristic impedance of the pair. The Dk of HDPE shown in FIG. 4 is 2.3 times greater than the Dk of air. This effective Dk of an HDPE pair separator with a hole present in the center will be lowered thanks to the presence of air between the conductors where the electric field is present. The degree to which the effective Dk will be lowered depends on the size and shape of the hole implemented. The more air introduced, the lower the effective Dk. For example, consider the design discussed in FIG. 4 with an optimally sized HDPE pair separator providing 0.45 mm separation between conductors achieving a differential characteristic impedance of 100 ohms. With a 0.25 mm diameter circular hole located in the center of the pair separator, the same 100-ohm characteristic impedance can now be realized with a 0.375 mm separation between conductors. The twisted pair orbit diameter will subsequently be reduced further from 1.55 mm to 1.475 mm.

As described above, a pair separator as shown in FIG. 4 requires approximately 719 cubic centimeters of material for 100 meters of 4 pair cable. A pair separator as shown in FIG. 5 will only require 424 cubic centimeters of material due to its smaller overall size and the presence of a hole in the material. Compared to traditionally insulated twisted pairs, this design reduces the amount of expensive insulating material by 69%.

The dielectric constant of a material also has a direct impact on the propagation speed of a high frequency signal traveling through the material. In a vacuum, high frequency signals travel at approximately 3×10⁸ meters per second. When traveling through a dielectric material, the velocity of propagation is inversely proportional to the Dk of the material.

$$Propagation Velocity = \frac{3 \times {10}^{8}}{Dk}$$

The impact on propagation velocity can be leveraged in a cable design by manipulating the size of the hole within the pair separators. Tightly twisted pairs have slower propagation times compared to loosely twisted pairs making delay skew (time delta between fastest pair and slowest pair propagation times) difficult to meet. Using a large hole in a tightly twisted pair relative to a loosely twisted pair, will favorably decrease the skew between these pairs by enabling a faster propagation velocity in the tightly twisted pair relative to the propagation velocity in the loosely twisted pair. With the ability to manipulate the propagation velocity in each individual pair and improve the delay skew between pairs, the window of possible pair lays is expanded. Either tighter twists, looser twists, or both can now be considered while still achieving the required delay skew. These new pair lay options could provide improved near end crosstalk performance when properly designed.

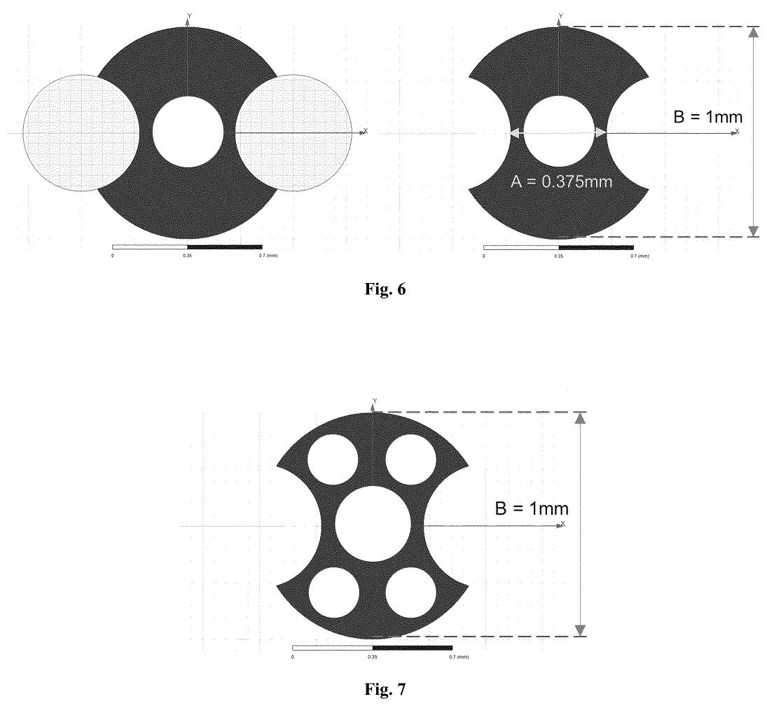

Other embodiments of the pair separator could be explored to further leverage the benefit of air within the pair separator. FIG. 7 shows an alternate embodiment that incorporates several holes within the pair separator that would lower the effective dielectric constant further which is shown to enable smaller dimensions and faster propagation velocities as well as significant material reductions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A communication cable comprising:
at least one pair of coated conductors; and
a wire separator having at least one hole in the cross section between each conductor of the at least one pair of conductors configured to simultaneously maintain a set distance between the conductors and a specific characteristic impendence.

2. The communication cable of claim 1, wherein the distance between the pair of conductors is approximately 0.375 mm and the characteristic impedance is approximately 100 ohms.

3. The communication cable of claim 2, wherein the profile of the pair separator has a surface area of approximately 527 mils².

4. The communication cable of claim 1, wherein the at least one pair of 1 coated conductors is four pairs of coated conductors leading to an outside diameter of the communications cable of approximately 172 mils.
